(19) United States
(12) Patent Application Publication
(10) Pub. No.: US 2010/0176269 A1
(43) Pub. Date: Jul. 15, 2010

(54) EASY-TO-CLEAN PEDESTAL FOR USE IN THE FOOD PROCESSING INDUSTRY

(75) Inventor: Marcel Couture, Saint-Henri (CA)

Correspondence Address: DARBY & DARBY P.C., P.O. BOX 770, Church Street Station, New York, NY, 10008-0770, US

(73) Assignee: G.E. LEBLANC INC., St-Anselme (CA)

(21) Appl. No.: 12/650,591

(22) Filed: Dec. 31, 2009

(30) Foreign Application Priority Data
Jan. 14, 2009 (CA) 2649715

(51) Int. Cl. F16M 5/00

(52) U.S. Cl. 248/677

(57) ABSTRACT

Disclosed is an easy-to-clean pedestal for use in the food industry, especially the meat processing industry, in order to support a piece of equipment. This pedestal is made of one single piece of material such as steel, that is flat and extends vertically with at least one folded side. Inasmuch as this pedestal is made of a single piece that is flat and free of interstices, remnants of meat or other contaminants that facilitate microbial growth, cannot be trapped. Moreover, its cleaning is much easier even with a water spray.

### FIELD OF THE INVENTION

The present invention relates to an easy-to-clean pedestal for use as a support for a piece of equipment in the food processing industry,

### BACKGROUND OF THE INVENTION

Food safety is an important issue in the food industry, especially the meat processing industry. By the very nature of the commercial slaughtering process, meat processing companies face serious challenges in producing products that pass government and industry standards and are safe for consumption. Meat contamination may occur during and after meat processing. The slaughtering process is a critical step where contamination may arise. During slaughtering, the carcasses of animals are processes and cut into several parts such as loin, ribs, etc. The processing is often accomplished automatically by animal carcass puller/cutter equipment. Usually, the carcass is placed on a conveyor system mounted onto a frame which comprises a working surface for engaging and pressing the carcass surface and moving it toward a cutting mean. This processing generates a multitude of small pieces of meat that soil not only the ground but also the frame, which, so far, is commonly supported by tubular, hollowed, jointed or grooved leg members or pedestals, in which the filth can be trapped and thus facilitate the growth of microbial pathogens resulting in an increased risk of contaminating the work place and eventually the meat itself. Accordingly, there is a need for developing pedestals for use in the food industry, especially the meat processing industry, which pedestals would be easier to clean.

### SUMMARY OF THE INVENTION

The object of the present invention is to provide an easy-to-clean pedestal for use in the food industry, especially the meat processing industry, in order to support a piece of equipment.

Typically, in the meat processing industry, use is made of equipment comprising a conveyor mounted onto a frame that is positioned onto a support surface. The frame is positioned onto the support surface by means of a plurality of vertical pedestals.

So, the object of the present invention is to provide pedestals which, contrary to those presently in use, are easy to clean.

More specifically, the object of the invention is to provide a pedestal for use in the food industry to support a piece of equipment, said pedestal being made of one single piece that is flat and extends vertically with at least one folded side.

Inasmuch as the pedestal according to the invention is made of a single piece that is flat and free of interstices, pieces of meat or other contaminants that facilitate microbial growth, cannot be trapped. Moreover, its cleaning is much easier even with a water spray.

In practice, the pedestal may have one or more folded sides. So, it can be L-shaped, Z-shaped or C-shaped when seen in horizontal cross-section.

According to a preferred embodiment of the invention, the pedestal has bottom ends devised to be anchored to a support surface such as the floor of a food processing factory.

In this particular embodiment, the pedestal can be anchored to the support surface by a method which comprises:
a. making slots into the support surface, said slots being configured to the receive the bottom ends of the pedestal;
b. inserting the bottom ends of the pedestal into the slots; and
c. anchoring the bottom ends of the pedestal by filling and covering the slots with a solidifying agent.

According to another preferred embodiment of the invention, the pedestal has a bottom end anchored to a support member installable onto the support surface.

In this other embodiment, the pedestal can be anchored to the support member by a method comprising:
d. fixing the bottom end of the pedestal onto the support member; and
e. positioning and adjusting the support member onto the support surface.

Other features and advantages of the present invention will be better understood upon reading the following non-restrictive description made with reference to the appended drawings.

### BRIEF DESCRIPTION OF THE DRAWINGS

FIG. 1 is a perspective view of a meat conveyor equipment having a frame supported by two different types of pedestals according to the invention.

FIG. 2 is a perspective view of a Z-shaped pedestal having two bottom ends anchored to a support block.

FIG. 3 is a perspective view of a Z-shaped pedestal having its bottom anchored to a support member installable onto a support surface.

FIG. 4 is a perspective view of a C-shaped pedestal having two bottom ends anchored to a support block.

FIG. 5 is a perspective view showing the way the bottom ends of the pedestals shown in FIGS. 2 and 4 are anchored to their support blocks.

### DETAILED DESCRIPTION OF THE INVENTION

As aforesaid, the present invention is directed to pedestals 1, 1′ and 1″ which are devised to be used in the food industry, especially the meat processing industry, to support a piece of equipment such as the frame 3 of a conveyor 2 onto a support surface like the floor of a factory.

Each of the pedestals 1, 1′ and 1″ according to the present invention, is made of a single piece of solid material such as, for example, stainless steel. The height, thickness and width of the pedestals 1, 1′ and 1″ are of course selected so as to fit with the height and weight requirement of the piece of equipment to be supported.

As shown in the drawings, the single piece that forms each of the pedestals 1, 1′ and 1″, is flat and extends vertically.

Each of the pedestals 1, 1′ and 1″ has an upper edge, a bottom edge and two lateral sides 4. As aforesaid, they are made of a single piece of material that is flat with no interstices, cracks, grooves, clefts, joints and the like. Such a flat structure is particularly advantageously in that it makes the pedestals easy to clean, and thus it efficiently reduces the possibility of microbial contamination.

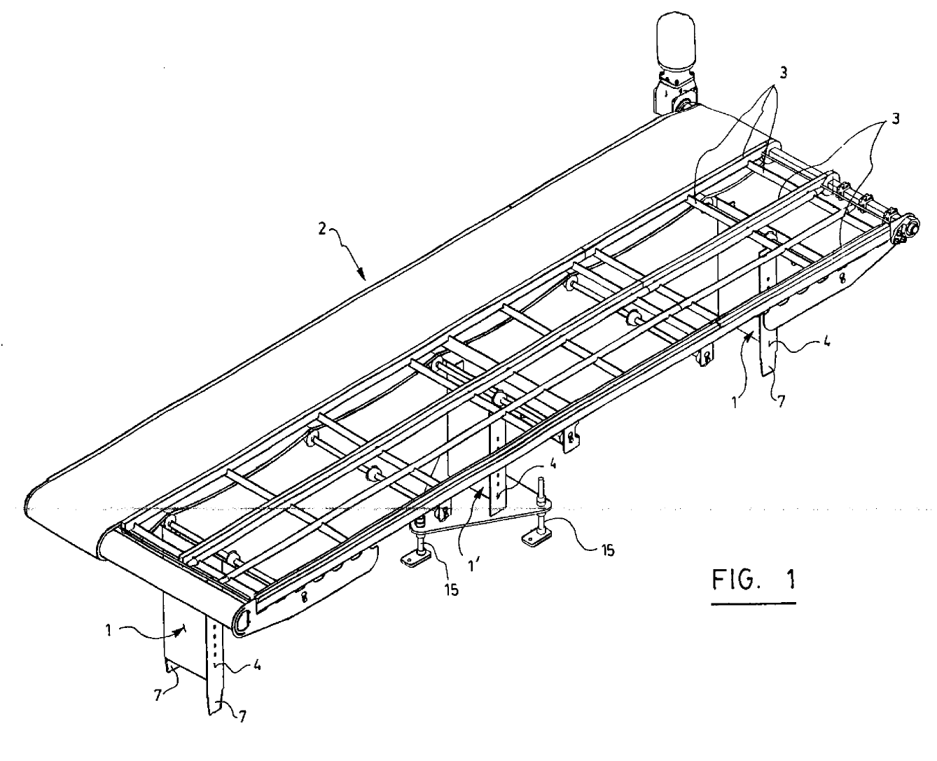

As aforesaid, each of the pedestals according to the invention has at least one of its lateral sides 4 folded so as to reinforce its structure. In the illustrated embodiments, the pedestals 1, 1′ and 1″ have both of their lateral sides 4 that are folded. The pedestals 1 and 1′ shown in FIGS. 1 to 3, have a Z-shape when seen in horizontal cross-section. The pedestal 1″ shown in FIG. 4, has a C-shape when seen in horizontal cross-section. As aforesaid, each of the pedestals according to the invention could however have only one of its lateral sides folded.

The advantage of such a shape is that it increases the stiffness of the pedestal. Thus, even when the pedestal is slim, it can support a heavy structure like a conveyor.

As shown in FIG. 1, the pedestals 1 and 1′ are generally arranged in parallel relationship with respect to each other along the length of the frame of the piece of equipment to be supported. Each of the pedestals 1 and 1′ has its upper edge engaged, hung on, clinched or otherwise affixed to the frame 3.

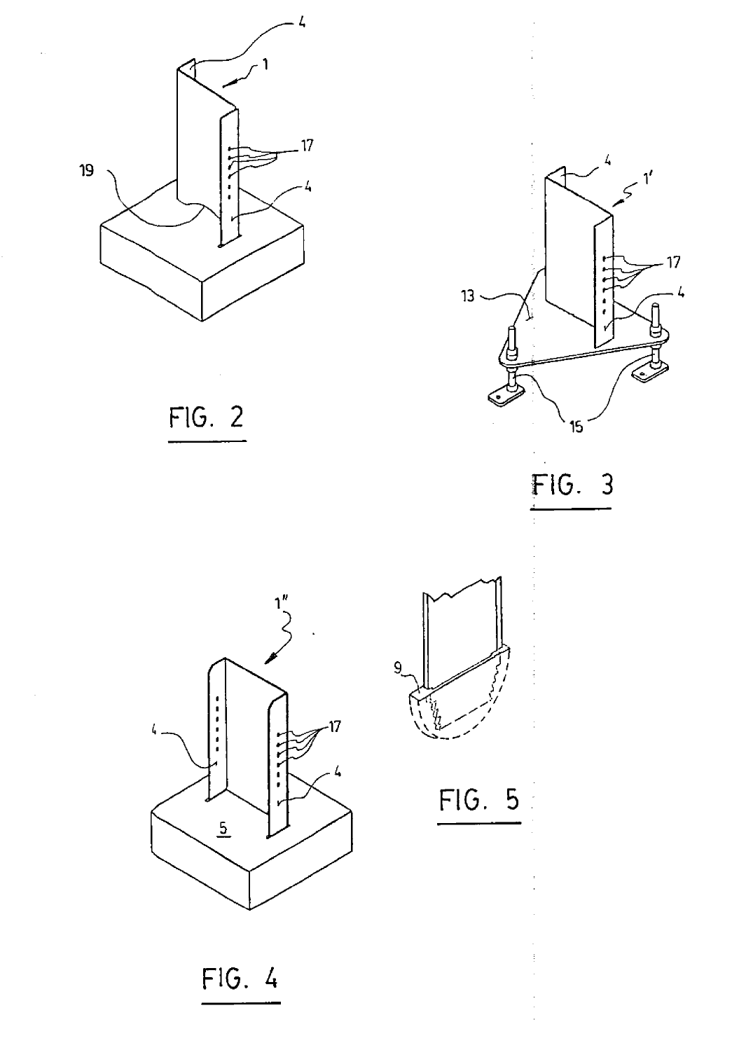

In the embodiments shown in FIGS. 2, 4 and 5, the pedestals 1 and 1″ are anchored into a supporting block 5. To do so, each of the bottom ends 7 of the folded lateral sides 4 of the pedestal projects downwardly so as to be inserted into a slot 9 made for this purpose in the supporting block 5. After such an insertion, a solidifying agent 11 such as epoxy or concrete, can be filled into the slot 9 to close it and hold in it the bottom end 7 of the lateral side 4 of the pedestal.

Of course, instead of being anchored into a supporting block 5, the pedestals 1 and 1″ could be anchored into slots made directly into the support surface or floor of the factory.

In all cases, the solidifying agent that is used, must provide enough rigidity and strength for keeping the pedestal in position while closing the opening formed by the slots in the floor, into which dust or contaminants could enter.

In the other preferred embodiment shown in FIGS. 1 and 3, the pedestal 1′ has its bottom edges fixed by welding or any other method, onto a support surface such as a plate 13 that acts as a platform. This platform is advantageously provided with legs 15 that are adjustable by means of screwable bolts. Such allows proper positioning of the pedestal 1′ onto the floor, whatever be the inclination or defect of the floor.

As shown in the drawings, the pedestals 1, 1′ and 1″ may have openings 7 in their folded sides. As shown in FIG. 2, the central portion 19 of the bottom edge of the pedestal 1, may also be shaped so as to leave a space on the supporting block 5. Such makes the cleaning of the equipment and floor easier, especially when such is done by water spray.

Thus, as may be appreciated, the pedestals according to the invention are very simple in structure and very easy to clean with for example, a water jet or the like. So, these pedestals substantially reduce the possibility of contamination when used in the food industry.

Of course, further modifications could be made to the embodiments disclosed hereinabove without departing form the scope of the present invention as defined in the appended claims.

What is claimed is:

1. A pedestal for use in the food industry to support a piece of equipment, said pedestal being made of one single piece that is flat and extends vertically with at least one folded side.

2. The pedestal according to claim 1, wherein the pedestal has a Z-shape when seen in horizontal cross-section.

3. The pedestal according to claim 2, wherein the pedestal has a plurality of transversal openings.

4. The pedestal according to claim 3, wherein the pedestal has bottom ends devised to be anchored into a support surface.

5. The pedestal according to claim 3, wherein the pedestal has a bottom end anchored to a support member installable onto a support surface.

6. The pedestal according to claim 1, wherein the pedestal has a C-shape when seen in horizontal cross-section.

7. The pedestal according to claim 6, wherein the pedestal has a plurality of transversal openings.

8. The pedestal according to claim 7, wherein the pedestal has bottom ends devised to be anchored into a support surface.

9. The pedestal according to claim 7, wherein the pedestal has a bottom end anchored to a support member installable onto a support surface.

10. A method of mounting the pedestal according to claim 4 in such a manner as to support a food processing equipment, said method comprising:
a. making slots into the support surface, said slots being configured to receive the bottom ends of the pedestal;
b. inserting the bottom ends of the pedestal into the slots; and
c. anchoring the bottom ends of the pedestal by filling and covering the slot with a solidifying agent.

11. A method of mounting the pedestal according to claim 8 in such a manner as to support a food processing equipment, said method comprising:
a. making slots into the support surface, said slots being configured to receive the bottom ends of the pedestal;
b. inserting the bottom ends of the pedestal into the slots; and
c. anchoring the bottom ends of the pedestal by filling and covering the slot with a solidifying agent.

12. A method of mounting the pedestal according to claim 5 in such a manner as to support a food processing equipment, said method comprising:
a. fixing the bottom end of the pedestal onto the support member; and
b. positioning and adjusting the support member onto the support surface.

13. A method of mounting the pedestal according to claim 9 in such a manner as to support a food processing equipment, said method comprising:
a. fixing the bottom end of the pedestal onto the support member; and
b. positioning and adjusting the support member onto the support surface.
